(19) United States
(12) Patent Application Publication
(10) Pub. No.: US 2005/0025530 A1
(43) Pub. Date: Feb. 3, 2005

(54) Gap spacing means for electrophotographic devices

(76) Inventor: Lester E. Cornelius, Oyster Bay, NY (US)

Correspondence Address: Charles E. Temko, 22 Marion Road, Westport, CT, 06880, US

(21) Appl. No.: 10/851,367

(22) Filed: May 24, 2004

Related U.S. Application Data
(60) Provisional application No. 60/490,548, filed on Jul. 28, 2003.

(51) Int. Cl. G03G 15/08

(52) U.S. Cl. 399/279

(57) ABSTRACT

A gapping device for maintaining a predetermined spaced relation between a rotating photoconductor sleeve and a rotating developer sleeve in an electrophotographic device. The device includes an exposed contact surface which is free of sharp edges to prevent or substantially reduce scoring in the non-print coated areas of one of the sleeves to maintain the gap at constant width.

### RELATED APPLICATION

Reference is made to my copending provisional application Ser. No. 60/490,548 filed Jul. 28, 2003, to which a claim of priority is made.

### BACKGROUND OF THE INVENTION

Printers, copiers, fax machines, and other electrophotographic devices use cylindrical photoconductor sleeves placed parallel to developer rollers. In particular, electrophotographic devices using monocomponent toner, which can be magnetic or electrostatic, use developer rollers with spacers that create a gap between the photoconductor sleeve and the developer roller. Monocomponent toner is toner which can be triboelectrically charged against the developer sleeve.

It is common construction to place the photoconductor sleeve in a floating relationship with the developer sleeve through a hinge arrangement springs applying pressure, thus causing the photoconductor to press against the developer sleeve. A parallel gap must be maintained between the photoconductor and the developer sleeve. This is commonly accomplished by placing a bearing with a raised step configuration on the developer sleeve. The photoconductor is forced by the compression springs to press against the step. A typical step is from 180-200 microns.

The electrical forces that drive electrophotography are most strongly influenced by the distance of the photoconductor/developer sleeve gap. These forces are described by the inverse/square rule of electrical forces. For example, if the gap changes by one-half, the effect on the electrical forces is four times greater. If the distance is increased by one-half, the effect on the electrical forces is four times less. Toner is either pushed or attracted across the gap from the developer sleeve to the photoconductor. The amount of toner that crosses the gap is dependent on the triboelectric charge on the toner, the voltage or electrical potential between the developer sleeve and the photoconductor, and the width of the gap. The gap has the most influence on the amount of toner that reaches the photoconductor.

A photoconductor sleeve rotates with the developer sleeve. As it rotates, it is abraded by the edges of the raised step of the gap spacer. The gap spacer generally has two edges. These have been made at right angles on at least one side. The sharp edge of the step causes faster wear on the photoconductor because of the hinge arrangement. The gap spacers are loosely fit around the developer sleeve to allow for rotation. This loose fit allows the gap spacers to cock toward one edge depending on the pressure of the springs and the accuracy of the parallel gap between the photoconductor and the developer sleeve. When these gap spacers favor one edge, the gap edges with right angles cut into the photoconductor surface.

As the gap spacers cut into the photoconductor the developer sleeve moves closer to the photoconductor. The coatings on the photoconductors are typically 26 microns thick. As the 180-200 micron step cuts into the photoconductor it reduces the width of the gap, creating a darker print. The cuts are not created in a predictable or uniform manner so that this creates problems in maintaining a uniform gap and the printing density then varies and print defects occur. It is not uncommon to see photoconductors brought to an unacceptable print quality condition due to the cuts caused by the gap spacers. While much more photoconductor life is left in the uncut areas, the photoconductor must be discarded because the gap varies in width because of the cuts.

### SUMMARY OF THE INVENTION

The object of the invention is to reduce the cutting effect of the gap spacers on developer sleeves used in electrophotography and extend the life of the photoconductor. This is done by a profile change in the shape of the gap spacer. There are various configurations which reduce the sharp exposed edge. Any reduction in the right angle at the edge of the step reduces the cutting effect. Chamfered edges of the step, rounded edges of the step, or a dome-shaped step greatly reduce the cutting effect and create greater stability in the photoconductor developer sleeve gap. The preferred embodiment of the edge profile of the raised step of the gap spacer is an arc that transitions to the flat of the step. This embodiment also can have a wider surface area for the flat surface of the step, thereby reducing the pressure per square inch.

### BRIEF DESCRIPTION OF THE DRAWINGS

In the drawings, to which reference will be made in the specification, similar reference characters have been employed to designate corresponding parts throughout the several views.

FIG. 1 is a schematic view showing a part of a photoelectric device comprising a part of the disclosed embodiment of the invention.

FIG. 2 is an elevational sectional view of an end gap spacing element forming part of the embodiment shown in FIG. 1.

FIG. 3 is a schematic view showing a known form of spacing element.

FIG. 3A is a schematic view shoving a first embodiment of the invention.

FIG. 4 is a schematic view showing an enlarged profile of a first embodiment of the invention.

FIG. 5 is a profile showing a first alternate form of a corresponding view showing an alternate embodiment of the invention.

FIG. 6 is a profile showing a second alternate form.

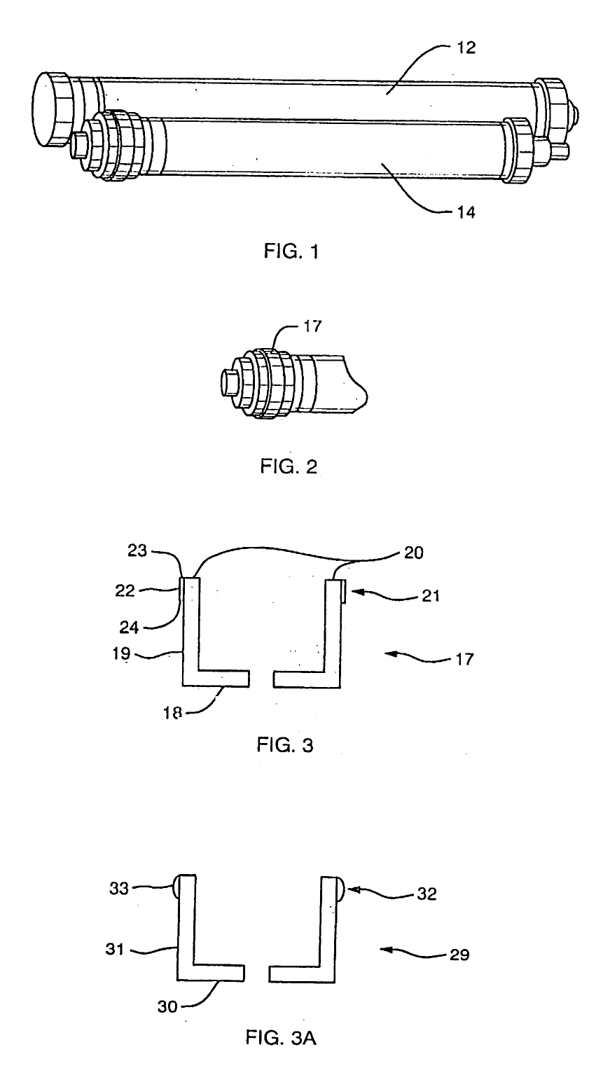

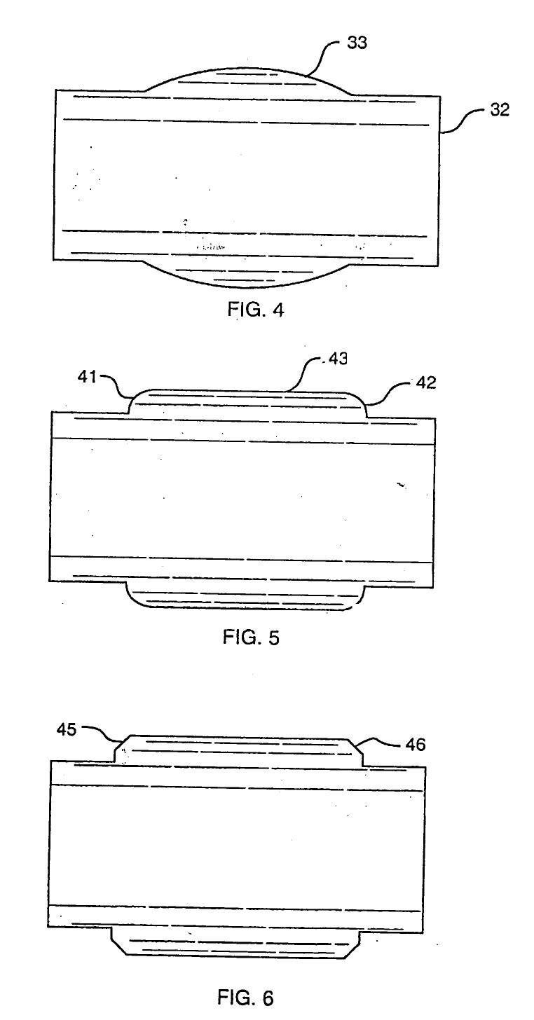

### DETAILED DESCRIPTION OF THE DISCLOSED EMBODIMENT

In accordance with the invention, the improved gapping means is installed in a known photocopier device (not shown) including that type of device in which the working parts form part of a replaceable cartridge which is periodically replaced when a toner hopper part of the same is exhausted. Copiers of this type include a known developer sleeve 12 which cooperates with a known photoconductor sleeve 14 which rotates in mutually spaced relation. As is known in the art, the developer sleeve attracts toner particles uniformly over its surface. The photoconductor sleeve is charged in accordance with an image to be reproduced, and during rotation, the particles of toner are attracted from the developer sleeve to the photoconductor sleeve to form an image which is later transferred to a printing medium, such as a sheet of paper. The gap maintained between the two sleeves is most conveniently determined by a pair of end caps 17 which are placed on one of the sleeves, the cap including a ring of desired diameter which contacts the coated surface of the contacted photoconductor sleeve. The cap element 17 includes an end wall 18 and a cylindrical wall 19 terminating in an edge 20 adjacent the spacing ring 21 which is often integrally formed.

The ring 21 includes a cylindrical surface 22 bounded by end edges 23 and 24 which form a right angle, as is known in the art. During operation, these edges 23-24 are resiliently urged into contact with the opposing coated surface of one of the sleeves 12-14, and with continued use, the end edges tend to cut into the coated surface at non-print edge areas, thus effectively altering the width of the gap. As might be expected, this cutting action is not uniform, as a result of which the gap is no longer maintained at uniform width with resulting deleterious effect on the degree of transfer of toner across the width of the print.

Referring to FIG. 3A, the improved end cap 29 includes an end wall 30, a cylindrical wall 31, and a spacing ring 32. Unlike the prior art, the outer surface 33 thereof is in the form of a rounded arc in which the end edges have been eliminated. Thus, when this surface contacts the coated surface of one of the sleeves, the cutting action described hereinabove does not occur, and thus the effective service life of the contacted coated surface is significantly improved.

In the version illustrated in FIG. 5, the outer surface of the spacing ring includes arcuate edge portions 41 and 42 and a medially positioned flat surface 43 which actually contacts the coated surface of one of the sleeves to produce a similar improved result. If desired, the longitudinal length of the spacing ring may be enlarged so that the effective contact area applies less pressure to the coated surface. As is understood by those skilled in the art, the ring may be formed as a separate piece, or formed integrally with the end cap cylindrical side wall.

In the version illustrated in FIG. 6, the end edge portions 45 and 46 are chamfered rather than arcuate.

I wish it to be understood that I do not consider the invention to be limited to the precise details shown and described in the specification, for obvious modifications will occur to those skilled in the art to which the invention pertains.

1. In an electrophotographic device having a cylindrical developer sleeve and a cylindrical photoconductor sleeve in spaced relation therebetween to form a gap for the flow of toner particles from said developer sleeve to said photoconductor sleeve, one of said developer and conductor sleeves having gap spacing means thereon for maintaining said gap, the improvement comprising: said gap spacing means having an exposed peripheral surface of other than rectangular cross-section.

2. The improvement in accordance with claim 1, in which said exposed surface is of arcuate cross-section.

3. The improvement in accordance with claim 1, in which said surface is of cross-section including arcuate end portions which merge with a medially-positioned flat contact surface.

4. The improvement in accordance with claim 1, in which said surface is of cross-section including chamfered end portions which merge with a medially-positioned flat contact surface.
